(19) United States
(12) Patent Application Publication
(10) Pub. No.: US 2009/0277715 A1
(43) Pub. Date: Nov. 12, 2009

(54) Furniture system for influencing the acoustics of a room

(76) Inventors: Alexander Scharer, GUMLIGEN (CH); Stefan Krenger, Thun (CH)

Correspondence Address: BIRCH STEWART KOLASCH & BIRCH, PO BOX 747, FALLS CHURCH, VA, 22040-0747, US

(21) Appl. No.: 11/990,987

(22) PCT Filed: Jul. 21, 2006
(86) PCT No.: PCT/CH2006/000381

§ 371 Date: Feb. 26, 2008

(30) Foreign Application Priority Data
Sep. 22, 2005 (EP) 05405554.6

(51) Int. Cl. G10K 11/16

(52) U.S. Cl. 181/286

(57) ABSTRACT

A furniture system for influencing the acoustics of a room comprises at least one item of furniture (21 a . . . 21 c) having a substantially cubic shape with four vertical side faces, a horizontal bottom and a horizontal top, wherein at least two, preferably at least three, of the side faces are modified and arranged for sound absorption in such a way that a sound absorption level of the item of furniture (21 a . . . 21 e) assumes its maximum value in a frequency range between 150 and 400 Hz; and at least one planar sound absorber (22, 23, 24) for increasing the sound absorption in a frequency range of above 400 Hz. The modified side faces are preferably designed as perforated panels, in particular as perforated metal plates, with a hole diameter of at least 2 mm each and a degree of perforation of at least 20%, wherein a fibrous material consisting of a porous material having a thickness of at most 1 mm is arranged on at least one side of the perforated panels.

### TECHNICAL FIELD

The invention relates to a furnishing system for influencing the acoustics of a room, to a piece of furniture for a furnishing system of this kind and to a method for influencing the acoustics of a room.

### PRIOR ART

The quality of a room, i.e. its suitability for the intended purpose (living, work, works training, etc.), is significantly dependent on its acoustic properties too. Different demands are placed on these according to the purpose for which a room is used. The reverberation time, a central parameter for characterizing the room acoustics, in a church, for example, will usually be longer than in a concert hall or even in a workroom, living room or works training room.

To begin with, the acoustics of a room are stipulated by the geometry of the room and the materials used for the floor, the walls and the ceiling. Other influences result from the furnishing of the room and also from people in the room.

A particularly important factor for offices, workrooms, works training and living rooms is good speech intelligibility. To ensure this, the reverberation time particularly in a frequency range from approximately 250 to 2000 Hz should not exceed a certain value (usually between 0.6 and 1.0 s). In addition, the reverberation time in usual rooms without acoustic optimization is different with different frequencies, the effect of which is that certain frequency ranges linger for a longer time relative to others and hence the timbre changes over time. Such frequency-dependent differences should likewise be reduced to an admissible degree.

To achieve satisfactory room acoustics, the appropriate design of the room geometry and the selection of the materials used are therefore supported by the use of specific furnishing elements which specifically influence the acoustics of rooms. Even greater significance is attached to these when a room which is acoustically unsatisfactory per se but which already exists is intended to be acoustically optimized for an intended use or when existing rooms are put to use with other acoustic requirements.

The furnishing elements are primarily able to take care of two tasks, namely absorbing sound and/or deflecting it. It is known practice to use flat absorber elements in the style of panels which are fitted in the wall and/or ceiling area and primarily have the task of absorbing sound and hence reducing the reverberation time overall. Acoustic room dividers are also known which are set up freestanding in the room and may additionally also have a sound-directing effect.

The known wall and ceiling panels cannot be integrated into any room with sufficient effective area, for example because large wall areas are covered by furniture immediately in front of them, because large window areas are present or because the absorbers can be integrated into the room's interior architecture or the lighting design only with difficulty. The known room dividers (partition walls) require additional space and thus reduce the usable room area, and they also cannot be positioned in their acoustically optimum arrangement but rather are primarily subject to the functional split of the room. It has moreover been found that the known means make it possible to get to grips with the problem of timbre changes only with a high level of complexity.

### PRESENTATION OF THE INVENTION

It is an object of the invention to provide a furnishing system which is associated with the technical field stated at the outset and which can be integrated into a large number of rooms, particularly into offices, workrooms, works training and living rooms, is space-saving and allows a considerable improvement in the room acoustics, particularly also in respect of the reduction of timbre changes.

The way in which the object is achieved is defined by the features of claim 1. In line with the invention, the furnishing system comprises at least one piece of furniture with an essentially cubic shape with four vertical side faces, a horizontal base and a horizontal top, where at least two, preferably at least three, of the side faces are modified and arranged for sound absorption such that a degree of sound absorption for the piece of furniture assumes its maximum in a frequency range between 150 and 400 Hz. In addition, the furnishing system comprises at least one flat sound absorber for increasing the sound absorption in a frequency range above 400 Hz.

The furnishing system therefore contains complementary elements whose acoustic properties complement one another. The range between 150 and 400 Hz contains the fundamental frequency of human speaking voices, and hence great importance is attached to this range when optimizing the room acoustics in offices, workrooms, works training and living rooms in which people stay and communicate with one another, make telephone calls, listen to the radio or watch television. However, investigations have now shown that particularly sound emissions in this frequency range are usually not attenuated to a sufficient degree by customary room furnishings. The reverberation time in this frequency range is therefore too long, the room is perceived to be noisy and speech intelligibility is impaired. At higher frequencies, the attenuation is greater, which results in the noise spectrum being shifted to the low-frequency range and hence in timbre changes. Customary flat sound absorbers such as ceiling or wall absorbers, acoustic panels, carpets, curtains, etc. also usually have their absorption maxima in a range above 400 Hz.

The inventive furnishing system now supports the sound absorption in the low frequency range by virtue of the indicated piece of furniture, which absorbs the sound particularly in the lower frequency range. Within the context of the inventive furnishing system, the flat absorbers, primarily arranged at the boundaries of the room (floor, walls, ceiling), and the three-dimensional piece(s) of furniture, possibly distributed in the room, therefore complement one another, so that good and as far as possible frequency-independent sound absorption can be achieved in the frequency area of interest between approximately 150 and approximately 2500 Hz.

A method for influencing the acoustics of a room therefore involves said piece of furniture or a plurality of such pieces of furniture being arranged such that a desired sound absorption is achieved in a frequency range from 150 to 400 Hz, and additionally at least one flat sound absorber is arranged such that a desired sound absorption is achieved in a frequency range above 400 Hz.

Preferably, the flat sound absorber is a panel which can be fitted on a room ceiling or a room wall. Such panels are known and allow a high level of sound absorption at frequencies of 400 Hz and more.

Alternatively, the sound absorption in this range is looked after by sound-absorbing flat room dividers (acoustic stand-up panels), or by floor coverings, ceiling or wall elements and/or flat textiles (e.g. carpets, curtains).

The modified side faces of the inventive piece of furniture are advantageously in the form of perforated plates, particularly in the form of perforated sheets, with a perforation diameter of at least 2 mm each and a degree of perforation of at least 20%, where at least one side of the perforated plates has a fibrous material arranged on it which is made of a porous material with a thickness of no more than 1 mm. It has been found that such a combination allows a high level of sound absorption even at low frequencies, but at the same time is also highly suitable for the furniture side faces in terms of stability, handling and esthetics.

Of particular advantage for the perforated plates in terms of esthetics, stability and handling are perforated sheets, but perforated plates made of wood or plastic are also suitable. In comparison with what are known as “microperforations”, where the perforation diameter is usually only approximately 0.5 mm and the degree of perforation (i.e. the ratio between the sum of the perforation areas and the total area) is much lower, significantly lower production costs are obtained for equivalent sound damping in the frequency range of interest. In comparison with other sound-absorbing materials of greater thickness (e.g. foams), the thin fibrous material allows an esthetically pleasing furniture design and requires no or at most slight design adjustment for existing furniture designs. It is also lightweight and easy to process by virtue of its being able to be adhesively bonded onto the perforated plate over a large area, for example.

Preferably, the fibrous material is arranged only on the inner side of the perforated plates, whereas the outer side of the perforated plates is uncovered. The outer side, on which greater demands are placed, is therefore formed by the comparatively resistant and easy-to-clean perforated plate, e.g. by a perforated sheet, while the fibrous material on the inner side is protected from exposure by the perforated plate.

Alternatively, the fibrous material is additionally or exclusively arranged on the outer side of the furniture. It is also possible to arrange the fibrous material differently for different side faces of the same piece of furniture.

The inventive piece of furniture is particularly suited to a fibrous material which is made of cellulose fibers and/or glass fibers embedded in an artificial resin matrix and preferably has a thickness of 0.1-0.4 mm. By way of example, an appropriate material is available from the company Freudenberg, Weinheim, Germany, under the name “SoundTex”. It has a thickness of just 0.2 mm but absorbs high levels of sound energy on account of its porous material structure and is particularly well suited to the inventive piece of furniture for the purpose of achieving the high level of sound absorption in the range 150-400 Hz. A coating of hot-melt adhesive means that the material can be fitted easily, quickly and permanently on the perforated plate, particularly on a perforated sheet.

The perforation diameter is advantageously between 3 and 8 mm and the degree of perforation is between 25 and 50%. This results in perforated plates which allow a high level of sound absorption when interacting with the fibrous material, are cheap to produce and provide the piece of furniture with sufficient stability. The specific values to be chosen for the perforation diameter and the degree of perforation are oriented particularly to the material used for the perforated plate.

Advantageously, the piece of furniture has a lattice-like structure which is formed by interconnected braces, where the side faces formed by the perforated plates are held between the braces. Such furniture can easily be used to build entire furniture systems, and the braces also cater for the structural stability of the furniture, so that the side faces can be designed for optimum sound absorption. In particular, the side plates can have a small thickness and an acoustically optimum degree of perforation.

In a piece of furniture based on the invention, one of the side faces of the piece of furniture can be formed by an openable door, the door not being modified for sound absorption. In particular, the door may be a foldaway, pull-out or slide-in door. It has been found that, normally, achieving a high level of sound absorption requires only the modification of three side faces, and additionally modifying the door does not increase the degree of absorption disproportionately. However, a door of conventional design can—particularly if the door needs to be mechanically robust, for example in order to be able to be used as a shelf when folded out—be produced much more cheaply than one which has been acoustically modified (comprising a perforated plate and a fleece, for example).

If maximum sound absorption is desired, the door can also be modified to absorb sound. In this case, it is constructed from two perforated sheets connected to one another parallel, for example, whose facing inner sides have the acoustic fleece fitted to them. Measurements have shown that a piece of furniture modified all around exhibits good sound absorption, contrary to expectations, that is to say that it does not become transparent to sound, as it were, despite the respective perforations on both sides.

The depth of the furniture used within the context of the invention is advantageously between 20 and 60 cm. In the context of the furnishing system, such furniture has a sound-absorbing effect not only with individual faces, e.g. with its end faces, but also as a body and therefore has an effect which is complementary to that of flat sound absorbers.

Further advantageous embodiments and combinations of features from the invention can be found in the detailed description which follows and in all of the patent claims.

### BRIEF DESCRIPTION OF THE DRAWINGS

In the drawings used to explain the exemplary embodiment:

FIGS. 1A, 1B show schematic views of furniture based on the invention;

FIG. 2A shows a schematic view of a perforated sheet for a side face of a piece of furniture based on the invention;

FIG. 2B shows a cross section through the edge region of the sheet for the side face;

FIG. 3 shows an array of furniture based on the invention for performing sound absorption measurements in the reverberation room;

FIG. 4 shows an illustration of the equivalent sound absorption area as a function of frequency for a conventional furniture element;

FIGS. 5-7 show illustrations of the sound absorption area as a function of frequency for furniture based on the invention;

FIGS. 8-10 show illustrations for comparing the sound absorption of a furniture element based on the invention with other sound absorbers; and

FIG. 11 shows a schematic illustration of an example of a furnishing system based on the invention.

In principle, identical parts in the figures have been provided with the same reference symbols.

### WAYS OF IMPLEMENTING THE INVENTION

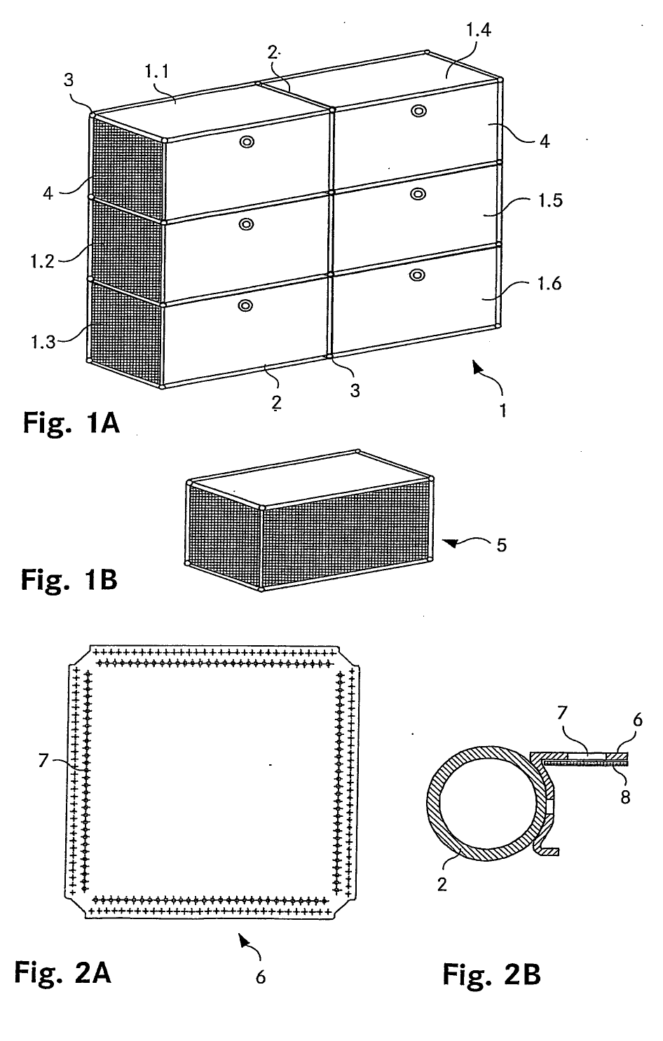

FIGS. 1A and 1B show schematic outer views of furniture based on the invention. FIG. 1A shows a piece of furniture 1 which is part of a furniture system and is made up of six elements 1.1 . . . 1.6. Each of the elements is cuboid and has the dimensions 750×395×375 mm (B×H×T). The dimensions of the piece of furniture 1 shown are 1525×1092×375 mm (B×H×T). The piece of furniture 1 comprises a lattice-like structure which is formed by chrome-plated steel tubes 2 which have the corner and node points screwed to chrome-plated brass spheres 3. Fitted between the chrome-plated steel tubes 2 are lining elements 4 made of powder-coated sheet metal. On the vertical fronts of the elements 1.1 . . . 1.6 the lining element 4 is a respective hinged door which can be folded out toward the front about a pivot axis at the lower edge of the door. The furniture system is of flexible design and, on account of the lattice-like structure, allows a very wide variety of furniture and furniture combinations to be built, as far as both the geometry and the lining elements used are concerned. By way of example, lining elements made of glass or another material may be used, the door can be omitted, or it can be replaced by a drawer or a slide-in door, for example.

FIG. 1B shows a piece of furniture 5 which is built from a single element, the back of the furniture being visible in this illustration.

The vertical side faces of the furniture 1, 5 on the right and left and at the back, i.e. the rear wall and the side walls, are provided with lining elements which are formed by perforated sheets onto which a sound-absorbing fleece has been adhesively bonded on the inside.

FIG. 2A shows a schematic view of a perforated sheet 6 for a side face, with only the respective outermost rows of the perforation being shown to assist clearer illustration. However, the perforation continues with the same perforation size and the same perforation intervals within the rows shown, so that the entire outer face of the sheet is evenly perforated. The perforations 7 are round and have a diameter of 5 mm, and the centers of adjacent perforations 7 in a row are at an interval of 10 mm. Adjacent rows are at an interval of 5 mm, and their perforations 7 are respectively displaced by half the perforation interval, i.e. by 5 mm. A degree of perforation of approximately 30% is therefore obtained, i.e. the total of the perforation areas is 30% of the total planar sheet area.

The sheet 6 shown in FIG. 2A has its edge regions folded inward, as shown schematically in cross section in FIG. 2B. It therefore forms a suitable receptacle for the steel tubes 2 of the furniture structure and can be held between them. The fleece 8 is adhesively bonded onto the inner side of the sheet. Its area corresponds approximately to the area of the planar region of the sheet 6, and the perforations 7 are therefore all covered by the fleece 8 on their inner side. The fleece 8 comprises cellulose fibers and glass fibers which are bonded by means of artificial resin. The fleece structure is shaggy, and its thickness is approximately 0.2 mm. This is suited to the fleece material SoundTex® C 1986 SP/WP from the company Freudenberg, Weinheim, Germany, for example.

Four pieces of furniture 1a . . . 1d as described above in connection with FIG. 1 were used to perform measurements (in accordance with ISO 354) in a reverberation room 9, the acoustic properties of different arrangements of modified side faces being examined.

The reverberation time Tᵣₑᵥ is subsequently understood, as is generally customary, to mean the period of time between the interruption time for a sound emission (including a damping period t₀) and the time t₆₀ which corresponds to a decrease in the sound pressure from 1 to 1000 (60 dB). From the reverberation time Tᵣₑᵥ and the volume of the room it is possible to determine the equivalent acoustic sound absorption area A using what is known as “Sabine's formula”:

$${T}_{rev} = 0.163 \frac{V}{A} .$$

The equivalent acoustic sound absorption area A is a measure of the absorption action of materials in the room and allows a direct comparison between different sound absorbers, particularly also between flat and three-dimensional sound absorbers. It corresponds to an ideal equivalent absorption means area, where an ideal absorption means is a (hypothetical) material which is 100% absorbent at all frequencies and does not produce any reflections (“open window”). It should be noted that the reverberation time Tᵣₑᵥ and hence also the equivalent acoustic sound absorption area A are dependent on the frequency f of the sound emission.

The reverberation room used for the measurements, which has a volume of 214 m³, has reverberation times of approximately 20 s at 100 Hz and of approximately 2 s at 5000, the two cutoff values of the frequency range detected in the context of the measurement.

In a first step, the reverberation time Tᵣₑᵥ of the empty reverberation room at frequencies from 100 Hz to 5000 Hz was measured using steps of one third of an octave at 100, 125, 160, 200, 250 . . . 5000 Hz. To this end, the sound emission used was white noise, and following interruption of the emission the acoustic level was measured using ten precision microphones distributed evenly in the room, so that the respective reverberation time could be determined.

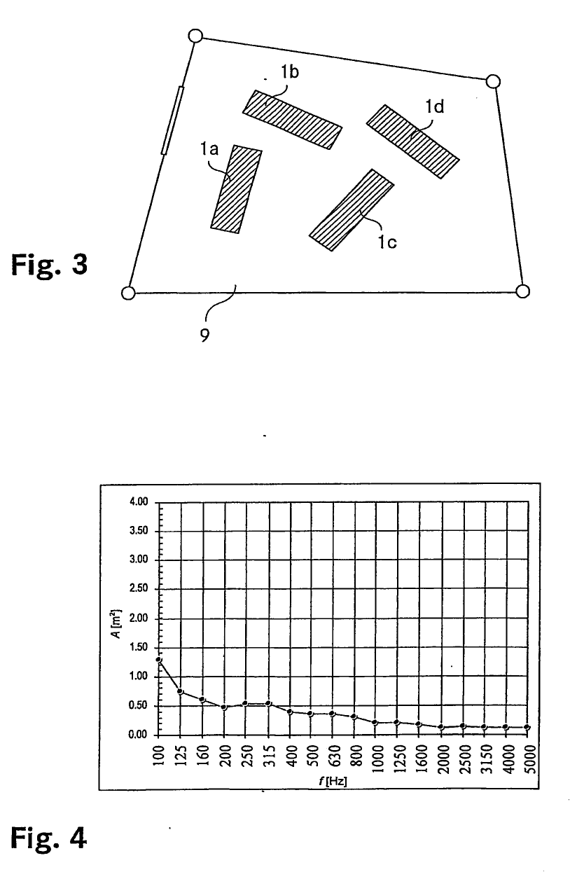

Next, the same method was applied to the reverberation room with the test specimens. This was done by setting up four pieces of furniture 1a . . . 1d from FIG. 1 in the reverberation room 9 as outlined in FIG. 3. Taking account of the volume of the reverberation room V and the measured reverberation times with and without a test specimen, it was now possible to determine the equivalent acoustic sound absorption areas A₁ (empty reverberation room) and A₂ (reverberation room with test specimen) for all examined frequencies, with Sabine's formula being used with a correction to compensate for the influences of temperature:

$$A = 55.3 \frac{V}{c T} ,$$

where c is the speed of sound in air at the examined temperature (c=331+0.6τ, when τ indicates the temperature in degrees Celsius). From the sound absorption areas A₁ and A₂ determined, it was then possible to determine the equivalent sound absorption area Aₓ of the test specimen itself by means of subtraction:

Aₓ=A₂−A₁.

This allows statements to be made about the sound absorption capability of the examined furniture configurations at different frequencies.

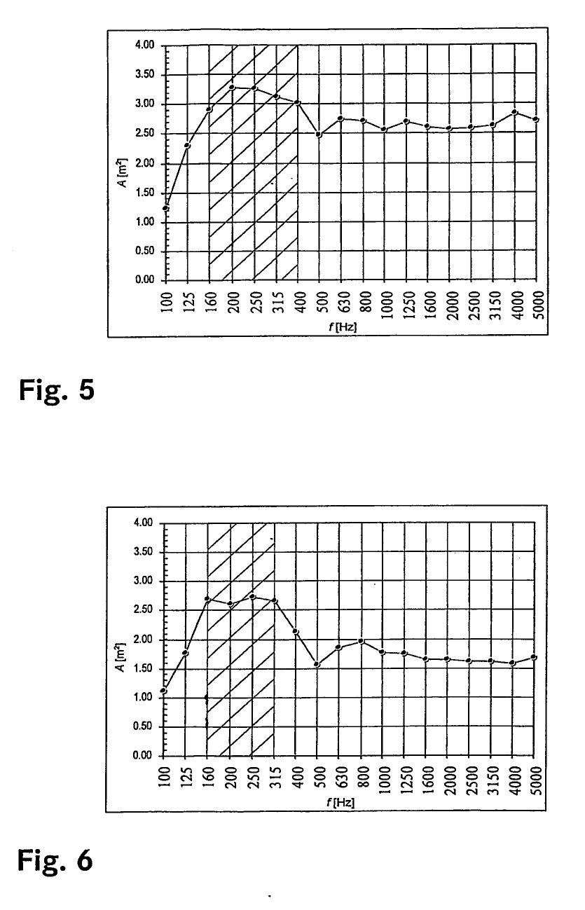

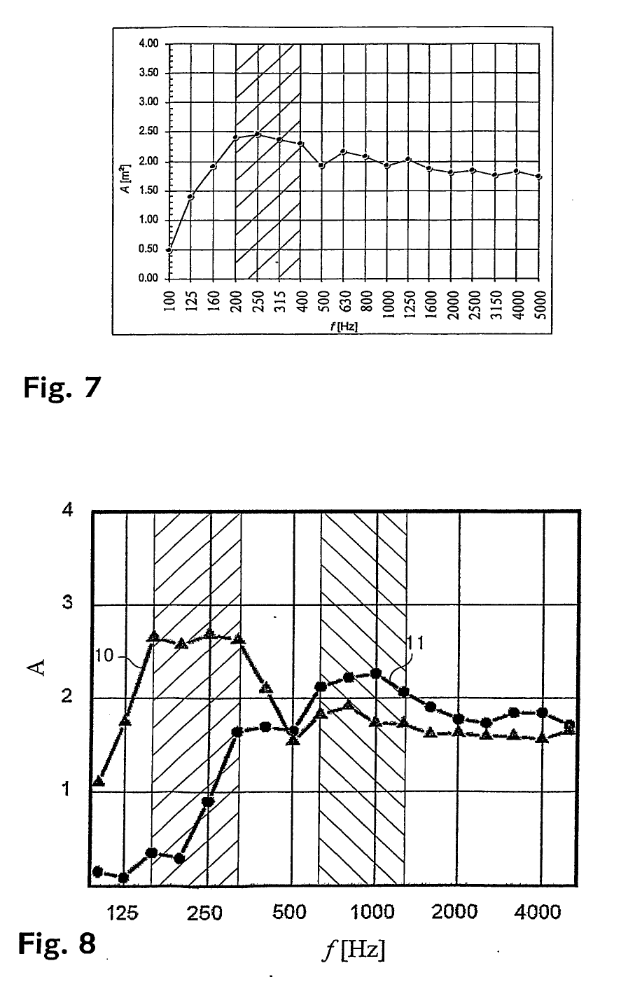

FIGS. 4-7 are illustrations of the equivalent sound absorption area Aₓ per element in m², dependent on the examined frequencies from 100 to 5000 Hz at which furniture with different designs of side faces and doors have been examined:

| | | | Side and |
|---|---|---|---|
| Furniture | Figure | Door | rear walls |
| 1 | FIG. 4 | Yes; unmodified | unmodified |
| 2 | FIG. 5 | Yes; modified | modified |
| 3 | FIG. 6 | Yes; unmodified | modified |
| 4 | FIG. 7 | No | modified |

Modified walls are designed as described above in connection with FIGS. 1 and 2, i.e. they are formed by a perforated sheet (with a degree of perforation of 30%), behind which the fleece described is arranged. The modified door comprises a respective perforated sheet with a fleece both on its inner side and on its outer side.

As can clearly be seen from the comparison of FIGS. 4 and 5, the modified faces result in greatly increased sound absorption at all frequencies above 100 Hz. The inventive piece of furniture, modified all around, exhibits particularly good sound absorption at frequencies between 160 and 400 Hz, the maximum sound absorption being obtained at 200-250 Hz.

FIG. 6 shows the absorption capability of a variant in which the door is unmodified. This has advantages insofar as the design of the door with perforated sheets and a fleece results in significantly greater costs than modification of the side walls and of the rear wall. As can easily be seen, although somewhat lower sound absorption is obtained, the basic character with maximum sound absorption in the range from 160 to 315 Hz is unaltered in comparison with the maximum variant. In this frequency range, the reduction in equivalent sound absorption area A is approximately 16% on account of the lack of modification to the door, while it is approximately 38% at higher frequencies.

FIG. 7 shows the absorption capability of another variant, in which there is no door, that is to say of an open shelf. The values are somewhat lower at low frequencies than in the case of the variant with the conventional door, and at higher frequencies they are somewhat higher. In this case too the basic character is the same, however, with an absorption maximum at 200 to 400 Hz.

Similar measurements were performed for other furniture configurations, where at least two respective side faces of the furniture were formed by perforated plates with acoustic fleece in line with the embodiment described further above. In all of these measurements, a maximum sound absorption in the frequency range between 150 and 400 Hz was observed.

FIGS. 8 to 10 show comparisons between the absorption capability of the modified piece of furniture based on the invention and known acoustic elements for sound absorption, with the equivalent absorption area per element again being indicated in m². For the comparisons, the piece of furniture shown in FIGS. 1 and 2 with modified side and rear walls but an unmodified door was used. The sound absorption curve for the piece of furniture thus corresponds to that in FIG. 6.

FIG. 8 shows a comparison relating to a flat display (as an example of a customary flat sound absorber) which is equipped with perforated plates and with a foam material over the whole area. As can be seen clearly from the illustration, the sound absorption of the piece of furniture (curve 10) significantly exceeds that of the display (curve 11) in a frequency range below 500 Hz, in some cases by a multiple. If such displays are to be used in this frequency range to achieve the same sound absorption as with the piece of furniture based on the invention, very large display areas are required. In the higher frequency range, the flat, acoustically optimized display exhibits a somewhat higher sound absorption than the piece of furniture.

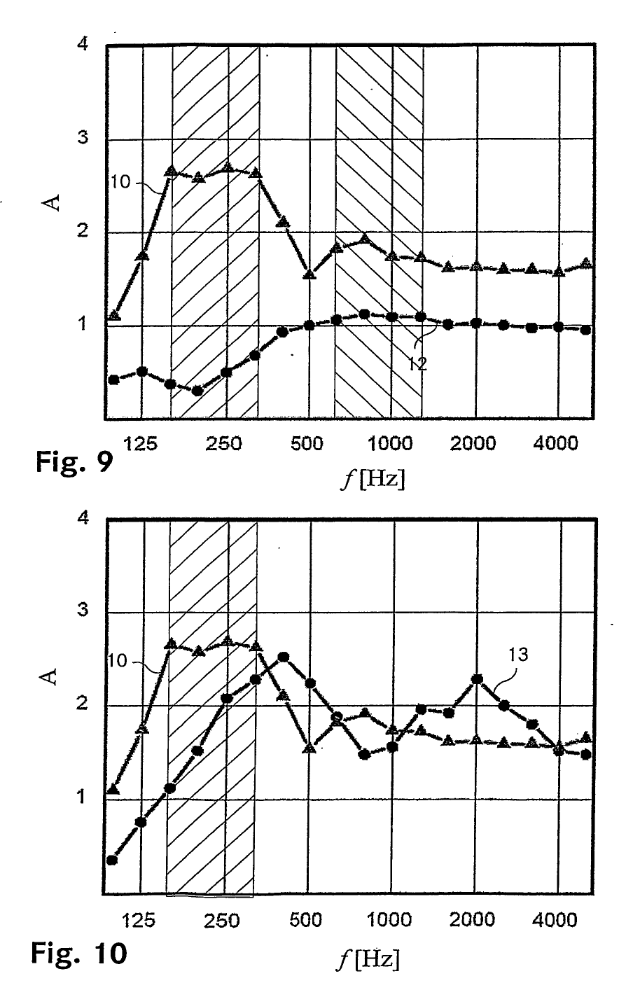

FIG. 9 shows a comparison relating to an, again flat, acoustic panel for freestanding setup with an area of 1.42 m², where in this case the piece of furniture (curve 10) exhibits higher sound absorption in the entire frequency range than the acoustic panel (curve 12). Again, the greatest difference is obtained in the range between 125 and 400 Hz. To achieve the same absorption action in this range, a panel area of approximately 7.4 m² would be necessary (assuming a frequency-independent linear relationship between area and sound absorption).

Finally, FIG. 10 shows the comparison with a wall or ceiling panel which is equipped with the same perforated plate/fleece combination as the piece of furniture illustrated above and which has an area of 4 m². Owing to the fact that the same sound-absorbing materials have been used, this illustration thus shows the qualitative and quantitative differences in the sound absorption using flat sound absorbers and using the three-dimensional piece of furniture based on the invention. Again, significantly higher sound absorption is achieved in the low frequency range (below 400 Hz) using the three-dimensional piece of furniture (curve 10) than using the flat sound absorber (curve 13), although the total of the projected areas of the piece of furniture is much smaller than the area of the wall or ceiling panel. At higher frequencies, particularly at those above 1000 Hz, better sound absorption by the flat absorber tends to be obtained.

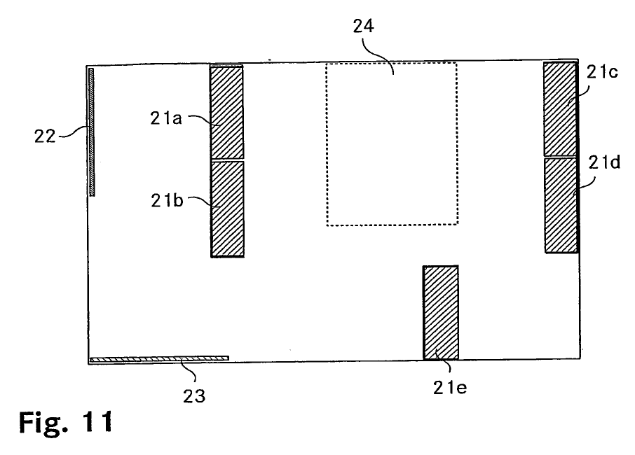

A furnishing system based on the invention therefore comprises both at least one piece of furniture based on the invention, which absorbs sound at frequencies of approximately 100-400 Hz, and at least one flat absorber, which additionally amplifies the absorption of sound at frequencies of more than 400 Hz such that a desired absorption value is achieved. An example of a furnishing system based on the invention is shown in FIG. 11. This system comprises five pieces of furniture 21a . . . 21e based on the invention with modified side faces as shown in FIG. 1 and also a plurality of flat sound absorbers, namely two wall absorbers 22, 23 and one ceiling absorber 24.

The invention is not limited to the exemplary embodiments shown. Particularly the furniture used may vary in terms of its shape, size and the materials used. On a piece of furniture, all the outer faces (that is to say possibly also the base and the top) can be modified for higher sound absorption, but it is also possible for just the two side walls or one side wall and the rear wall to be modified, for example. Within the context of a furnishing system based on the invention, it is possible to use a plurality of, including different, pieces of furniture and also a plurality of, including different, flat sound absorbers.

In summary, it can be stated that the invention provides a furnishing system which can be incorporated into a large number of rooms, particularly into offices, workrooms, works training and living rooms, is space-saving and allows a considerable improvement in the acoustics of a room, particularly also in terms of reducing changes in timbre.

1. A furnishing system for influencing the acoustics of a room, comprising
a) at least one piece of furniture (1, 1.1 . . . 1.6, 5, 21a . . . 21e) with an essentially cuboid shape with four vertical side faces, a horizontal base and a horizontal top, where at least two, preferably at least three, of the side faces (4) are modified and arranged for sound absorption such that a degree of sound absorption for the piece of furniture (1, 1.1 . . . 1.6, 5, 21a . . . 21e) assumes its maximum in a frequency range between 150 and 400 Hz; and also
b) at least one flat sound absorber (22, 23, 24) for increasing the sound absorption in a frequency range above 400 Hz.

2. The furnishing system as claimed in claim 1, characterized in that the modified side faces (4) are in the form of perforated plates (6), particularly in the form of perforated sheets, with a perforation diameter of at least 2 mm each and a degree of perforation of at least 20%, where at least one side of the perforated plates (6) has a fibrous material (8) arranged on it which is made of a porous material with a thickness of no more than 1 mm.

3. The furnishing system as claimed in claim 2, characterized in that the fibrous material (8) is arranged on an inner side of the perforated plates (6), whereas an outer side of the perforated plates (6) is uncovered.

4. The furnishing system as claimed in claim 2, characterized in that the fibrous material (8) comprises cellulose fibers and/or glass fibers embedded in an artificial resin matrix and preferably has a thickness of 0.1-0.4 mm.

5. The furnishing system as claimed in claim 2, characterized in that the perforation diameter is between 3 and 8 mm and the degree of perforation is between 25 and 50%.

6. The furnishing system as claimed in claim 2, characterized in that the piece of furniture (1, 1.1 . . . 1.6, 5, 21a . . . 21e) has a lattice-like structure which is formed by interconnecting braces (2), the side faces (4) formed by the perforated plates (6) being held between the braces (2).

7. The furnishing system as claimed in claim 1, characterized in that one of the side faces (4) of the furniture (1, 1.1 . . . 1.6, 5, 21a . . . 21e) is formed by an openable door, the door not being modified for sound absorption.

8. The furnishing system as claimed in claim 1, characterized in that a depth of the piece of furniture (1, 1.1 . . . 1.6, 5, 21a . . . 21e) is between 20 and 60 cm.

9. The furnishing system as claimed in claim 1, characterized in that the flat sound absorber (22, 23, 24) is a panel which can be fitted on the ceiling of a room or the wall of a room.

10. A piece of furniture, particularly for a furnishing system as claimed in claim 1, with an essentially cuboid shape with four vertical side faces, a horizontal base and a horizontal top, where for the purpose of sound absorption at least two, preferably at least three, of the side faces (4) are modified and arranged for sound absorption such that a degree of sound absorption for the piece of furniture (1, 1.1 . . . 1.6, 5, 21a . . . 21e) assumes its maximum in a frequency range between 150 and 400 Hz.

11. The piece of furniture as claimed in claim 10, characterized in that modified side faces (4) are in the form of perforated plates (6), particularly in the form of perforated sheets, with a perforation diameter of at least 2 mm each and a degree of perforation of at least 20%, where at least one side of the perforated plates (6) has a fibrous material (8) arranged on it which is made of a porous material with a thickness of no more than 1 mm.

12. A method for influencing the acoustics of a room, where at least one piece of furniture (1, 1.1 . . . 1.6, 5, 21a . . . 21e) with an essentially cuboid shape with four vertical side faces, a horizontal base and a horizontal top, where for the purpose of sound absorption at least two, preferably at least three, of the side faces (4) for sound absorption are modified and arranged such that a degree of sound absorption for the piece of furniture (1, 1.1 . . . 1.6, 5, 21a . . . 21e) assumes its maximum in a frequency range between 150 and 400 Hz, is arranged such that a desired sound absorption is achieved in a frequency range from 150 to 400 Hz and where additionally at least one flat sound absorber (22, 23, 24) is arranged such that a desired sound absorption is achieved in a frequency range above 400 Hz.

13. The furnishing system as claimed in claim 3, characterized in that the fibrous material (8) comprises cellulose fibers and/or glass fibers embedded in an artificial resin matrix and preferably has a thickness of 0.1-0.4 mm.

14. The furnishing system as claimed in claim 3, characterized in that the perforation diameter is between 3 and 8 mm and the degree of perforation is between 25 and 50%.

15. The furnishing system as claimed in claim 4, characterized in that the perforation diameter is between 3 and 8 mm and the degree of perforation is between 25 and 50%.

16. The furnishing system as claimed in claim 3, characterized in that the piece of furniture (1, 1.1 . . . 1.6, 5, 21a . . . 21e) has a lattice-like structure which is formed by interconnecting braces (2), the side faces (4) formed by the perforated plates (6) being held between the braces (2).

17. The furnishing system as claimed in claim 4, characterized in that the piece of furniture (1, 1.1 . . . 1.6, 5, 21a . . . 21e) has a lattice-like structure which is formed by interconnecting braces (2), the side faces (4) formed by the perforated plates (6) being held between the braces (2).

18. The furnishing system as claimed in claim 5, characterized in that the piece of furniture (1, 1.1 . . . 1.6, 5, 21a . . . 21e) has a lattice-like structure which is formed by interconnecting braces (2), the side faces (4) formed by the perforated plates (6) being held between the braces (2).

19. The furnishing system as claimed in claim 2, characterized in that
one of the side faces (4) of the furniture (1, 1.1 . . . 1.6, 5, 21a . . . 21e) is formed by an openable door, the door not being modified for sound absorption.

20. The furnishing system as claimed in claim 3, characterized in that one of the side faces (4) of the furniture (1, 1.1 . . . 1.6, 5, 21a . . . 21e) is formed by an openable door, the door not being modified for sound absorption.
